(19) United States
(12) Patent Application Publication
(10) Pub. No.: US 2026/0104866 A1
(43) Pub. Date: Apr. 16, 2026

(54) APPLICATION AND WEBSITE DEVELOPMENT PLATFORM FOR AUTOMATED RECOMMENDATIONS OF CODE INTEGRATION OPTIONS

(71) Applicant: PAYPAL, INC., San Jose, CA (US)

(72) Inventors: Asish Mohanty, Santa Clara, CA (US); Sarat Babu Annapaneni, Edison, NJ (US); Mudita Tiwari, Cupertino, CA (US); Shivani Bayala Banerjee, San Jose, CA (US); Michael Pietro Durfey, San Jose, CA (US); Sam Alfares, Chicago, IL (US)

(21) Appl. No.: 18/913,131

(22) Filed: Oct. 11, 2024

(51) Int. Cl. G06F 8/38

(52) U.S. Cl. CPC G06F 8/38

(57) ABSTRACT

There are provided systems and methods for an application and website development platform for automated recommendations of code integration options. An online transaction processor or other service provider may provide computing services and platforms to entities including merchants for electronic transaction processing and other account services. To provide for code integrations of the computing services with software platforms of merchants, such as software systems for merchant websites and applications, the service provider may provide a merchant development platform where merchants may provide information to an AI assistance and engine that may assist the merchant with identifying computing services of interest and use by the merchant for their software platform. The computing services may require integration with the software platform, such as through implementation of computing code to call APIs of the computing service, which may be intelligently generated and provided via the development platform.

### TECHNICAL FIELD

The present application generally relates to computing services used on different software platforms, and more particularly to predicting and recommending computing code integrations of computing services on software platforms.

### BACKGROUND

Online service providers may offer various services to end users, merchants, and other entities. This may include providing computing services through different software applications, websites, platforms, and resources, such as those that may be involved with digital transaction processing. For example, computing services may include those used to process transactions through electronic transaction processing data flows, services, and other computing resources. Further, the service provider may provide and/or facilitate the use of applications and websites for online payments, peer-to-peer (P2P) transfers, and/or marketplaces to different entities including merchants. However, establishment and use of these computing services require merchants and other entities to onboard with the service provider, identify a computing service of interest or need, and implement code for calls to those services on their platforms. These entities may encounter difficulties in finding the required resources to properly integrate and update computing code that allows the entities to utilize the computing services of service providers. This may lead to entities using old or “legacy” APIs and code integrations instead of newer, faster, and/or more efficient APIs, as well as being unaware of other computing services that may be beneficial to the entities, such as for improved data security and fraud protection. As such, there is a need to provide an automated system for identifying available computing services and code integrations recommended for entities to facilitate the use of these computing services in a more efficient, streamlined, and faster process and interface.

### BRIEF DESCRIPTION OF THE DRAWINGS

FIG. 1 is a block diagram of a networked system suitable for implementing the processes described herein, according to an embodiment;

FIGS. 2A and 2B are exemplary system architectures for providing a development platform where merchants and other entities may view recommendations of code integrations for computing services on software platforms, according to an embodiment;

FIG. 3 is an exemplary diagram of components of a development platform for code integrations, according to various embodiments;

FIGS. 4A-4C are flowcharts of exemplary calls executed by a development platform for code integrations of computing services on software platforms, according to an embodiment;

FIG. 5 is a flowchart for an application and website development platform for automated recommendations of code integration options, according to an embodiment; and

FIG. 6 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for automated recommendations of code integration options for an application and website development platform. Systems suitable for practicing methods of the present disclosure are also provided.

A user may wish to process a transaction, such as for a payment to a merchant, through an online service provider. The user may pay for one or more transactions with a merchant using a digital wallet or other account with the online service provider, such as a digital transaction processor (e.g., PayPal®). As such, the merchant may utilize these online service providers for particular computing services, such as to process transactions, create and/or login to accounts with the service provider and/or the merchant, provide risk analysis and/or fraud detection, and other computing services provided through applications, websites, resources, and processors of the service provider. Other service providers may also provide different services to other types of entities, such as computing services for social networking, microblogging, media sharing, messaging, business and consumer platforms, and the like.

As such, the merchant (or other entities) may have software platforms, such as applications and websites, where the merchants may offer their products, services, and other items to users, such as customers and consumers. During the provision of such items, the merchant may desire to incorporate the service provider's computing services within their software platform so that the service may be provided, accessed, and/or linked on the merchant's platform in place of requiring users to navigate to the service provider's application, website, and/or other platform. In order for merchants to provide the services of the service provider to users for processing transactions with the merchants, the service provider may provide operations for merchants to onboard and setup software and computing code integrations with the service provider through one or more merchant websites, systems, applications, and the like. However, merchants may be unaware of the products that service providers offer via their computing services, as well as how to integrate such computing services into their software platforms. Merchants may also use old, past, and/or “legacy” computing services of those products and application programming interfaces that allow external interfacing with the computing services, which may be inefficient, less secure, and/or offer fewer computing services and resources to the merchants. However, due to the cumbersome manual efforts required to update code, merchants may improperly integrate services or forego updating to more current code implementations that utilize more efficient, faster, more secure, and/or improved computing service usage and implementation.

For example, initially during setup of a merchant account and/or platform, merchants may onboard with the service provider to obtain access to accounts and computing services and utilize corresponding services during the course of business or other interactions with customers, clients, and/or entities. This may include accessing computing service setups (including software development kit (SDK) usage and setup, code snippets, and other data for code integrations of the service provider's computing service(s) with the merchant's software platform), application and/or website setup and configuration, and the like. Conventionally, merchants and other entities would be required to manually search for and locate computing services and other products of a service provider that are of interest, as well as look up API documentation, computing code snippets, SDKs, and the like for integration of such computing services on or in other software platforms of the merchants or other entities.

As such, this process is time and labor consuming, and may lead to inefficient or suboptimal solutions, thereby creating computing systems that waste computing resources, processing power, and/or encounter errors and failures. To address these issues with conventional systems, a service provider, as discussed herein, may provide an intelligent artificial intelligence (AI) engine that may implement machine learning (ML) models, neural networks (NNs), LLMs, and the like for recommendations of computing services and other products of the service provider that may be of interest or use to the merchant, and/or other entity, as well as provide automated code generation of integration and/or migration of computing code for the merchant to the most recent, updated, and/or newest available code of the service provider. This may be done using an AI engine that may utilize ML models for intelligent recommendations based on merchant information, past searches, past usages of computing services, API specifications and/or documentation, customer knowledge or customer base information, and the like. As such, the service provider may offer a merchant development platform where merchants may view recommendations of computing services and other products with computing code and software integrations through a code review and test panel where such integrations may be facilitated in a faster, more seamless, and more coordinated manner.

For example, an AI engine may include one or more AI models, such as LLMs, ML models, NNs, conversational AIs, generative AIs, and the like, to interact with, converse with, and/or propose offers and recommendations to merchants, service provider agents assisting merchant with code integrations, or other users or entities. The AI engine may be provided through a development portal that may include one or more personalized and/or customized user interfaces (UIs) where merchants may view recommended computing services with recommended code integration for computing services of the service provider with the software platform of the merchant. The AI engine may include generative pretrained transformers (GPTs) including ChatGPT™, Bidirectional Encoder Representations from Transformers (BERT), a Robustly Optimized BERT Approach (RoBERTa), and the like, as well as general purpose or domain specific LLMs, to interact with merchants. Other types of LLMs and/or generative AIs may also be used, as well as NNs, deep learning models, ML models, rule-based engines, and the like that may be used to predict computing services of interest or use by certain merchants, such as based on the merchants' searches, interests, sales, products, software platform, business or merchant category, etc.

Training of the AI engine may be performed using background data for the service provider and/or merchants of the service provider, such as the available computing services and/or products of the service provider, previous code integrations, updates or changes to code and code integrations, legacy code updates to new code, and the like. Further, past onboarding experiences, experience feedback, and/or use or engagement with computing services, products, and the like of the service provider by merchants may be used. During training of the AI engine, the model may be trained to make predictions and recommendations of computing code and/or code changes for code integrations. These recommendations may be used to determine new integrations, such as where the merchant may not previously have integrated a computing service with their software platform, as well as update and/or upgrade existing integrations from legacy code and/or code snippets, components, statements, endpoints, etc., to new, more optimized, and/or more efficient integrations and code.

Initially, the merchant may access the discovery platform and service provider system for the AI engine. The AI engine may then request information from the merchant, such as by asking or inquiring about the merchant's products of interest and/or business, ideal payments and/or payment/transaction processing solutions of interest, software platform, APIs and software documentation, desired code, etc., or the AI engine may otherwise determine this information from available knowledge about the merchant The AI engine may also request merchant data or may retrieve such data from one or more internal or external sources, such as one or more databases of merchant information, account data, and the like. The AI engine may then provide an AI personalized experience where the AI engine may predict and suggest different computing services of interest or potential use to the merchant based on a predictive or intelligent processing and/or decision-making, such as through use of one or more AI models. During the AI personalized experience, the merchant information may be processed with information for computing services, integrations, and the like of the service provider by one or more AI models to make intelligent decisions and recommendations of computing services that would be of use or interest to the merchant, as well as recommend legacy code updates and upgrades for existing service usages by the merchant. With the recommendations, computing code for an integration of each computing service (e.g., through API call structures and configurations, code snippets, SDKs, etc.) may be provided to the merchant.

To generate recommendations and computing code, an LLM (or another generative AI model) may be used by the AI engine. An LLM may be prompted to generate a recommendation and/or sample code for the integration of the computing service. In this regard, to prompt the LLM, the selected data (e.g., merchant search and/or query, merchant lookup actions or requests, merchant information, software platform information and parameters, available computing services, source code and code integrations, API specifications and parameters etc.) may be provided to the LLM with an LLM prompt, such as a statement question, query, request, or the like, which may provide an instruction to the LLM with examples or information for executing those instructions and returning a result. The data provided with the prompt may correspond to the requested output, such as the recommendation for a computing service of interest to the merchant and/or the request for sample code, API calls, and/or code snippets or packages, etc., for implementation of the computing service in a software platform of the merchant. While LLMs may be utilized for their conversational capabilities with generalized or domain-specific knowledge and knowledge bases (e.g., corpora of documents on which the LLMs may be trained), other types of ML models, NNs and/or deep learning models, and the like may be trained and used.

Where code generation is required for service implementation and integration, an LLM may generate the code and/or code snippets, samples, classes, API configurations, and the like through intelligent processing using the trained layers, neurons, trees and/or branches, clusters, and/or other ML process. The output of the LLM may correspond to a code data package, which may be output within one or more personalized UIs of the development platform of the service provider. This may include a code viewing, testing, and/or retrieving panel, window, field, or the like within a UI of the development platform. The merchant may then view sample code, such as an API call structure with a header, body/payload, digital signature, and/or authenticity field, etc., and may determine how the code may be implemented and integrated with their software platform for use of and/or calls to the computing service. The code review window or UI may also provide instructions for code integration and/or use, such as how to adjust the code for particular parameters of the merchant's software platform, how to change or specify endpoints, etc. As such, the UI may be dynamically configured for the merchant to view a merchant-specific recommendation and integration.

In this regard, the AI engine may leverage and utilize specifically trained ML models including LLMs and other generative AIs to provide a personalized AI experience through a development portal that allows merchants and other entities to discover and integrate computing services in a faster and seamless manner. The AI engine may automatically determine computing services of interest and potential use by these entities based on their activities and software platforms and may provide computing code to integrate such computing services automatically without manual efforts. This reduces the potential errors and time to integrate computing services, as well as migrate software platforms to new computing code, APIs, and/or other update configurations for computing services, which provides more efficient and optimized interactions between different computing platforms. As such, the service provider may provide an improved computing platform for computing services that are utilized by external and third-party software platforms.

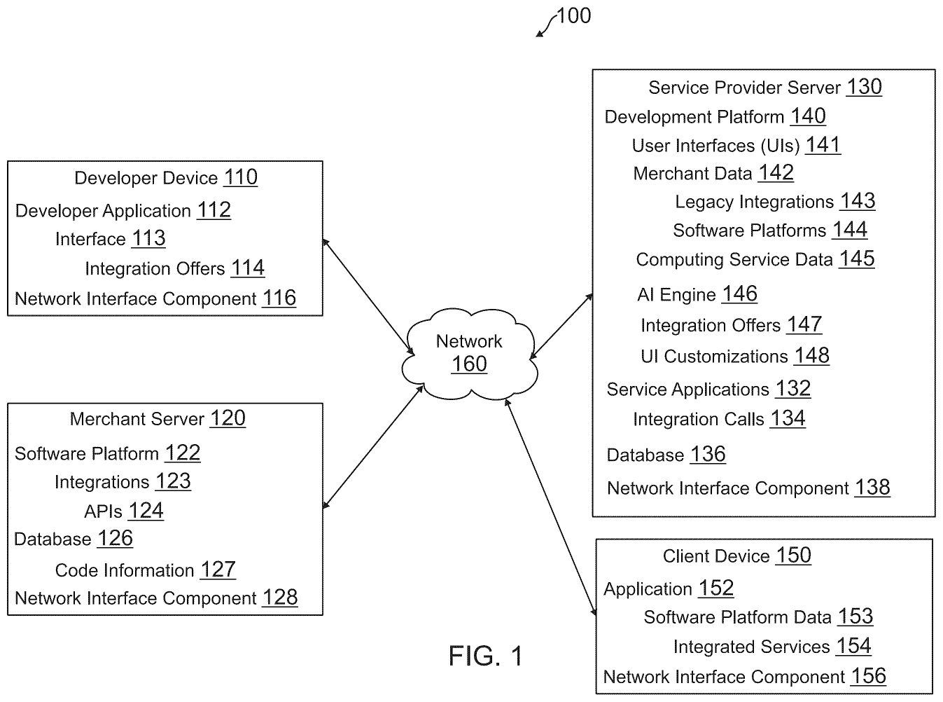

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, and/or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a developer device 110, a merchant server 120, a service provider server 130, and a client device 150 in communication over a network 160. Developer device 110 may be utilized by a merchant or other user to communicate over network 160 with service provider server 130 and/or the merchant server 120, where service provider server 130 may provide various data, operations, and other functions over network 160 to facilitate usage of computing services with merchant server 120. In this regard, merchant server 120 may be used to provide products and services to consumers and customers (e.g., via client device 150) through one or more software platforms, which may incorporate the services of service provider server 130 on such platforms. As such, developer device 110 may be utilized to view, browse, and request code integrations of such computing services and/or to migrate to new code and code integrations on merchant server 120. Service provider server 130 may provide a development portal and platform for computing service recommendation and code integration generation, which may be accessed and utilized by a merchant via developer device 110 and used to configure merchant server 120 for computing service usage and code integrations. Merchant server 120 may then be accessed and used by client device 150 (e.g., a device of a customer or consumer), which may utilize the integrated computing services.

Developer device 110, merchant server 120, service provider server 130, and client device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Developer device 110 may be implemented as a communication device that may utilize appropriate hardware and software configured for wired and/or wireless communication with merchant server 120 and service provider server 130 over network 160. For example, in one embodiment, developer device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Developer device 110 of FIG. 1 includes and/or is associated with an developer application 112, a database 116, and a network interface component 118, implementations of which are discussed further below. The developer application 112 may correspond to executable processes, procedures, and/or applications with associated hardware. In other embodiments, developer device 110 may include additional or different modules having specialized hardware and/or software as required. In some embodiments, the merchant server 120 includes some or all of the functionality of the developer device 110.

Developer application 112 may correspond to one or more processes to execute software modules and associated components of developer device 110 that may be utilized by a merchant to access the features, services, and platforms provided by service provider server 130. Developer application 112 may be used for development of software platforms of the merchant and integration of the software platforms with the computing services provider by service provider server 130. For example, developer application 112 may correspond to a browser application or native software application that may be utilized to configure a software platform 122 on merchant server 120 and/or access a development platform 140 on service provider server 130 for use with configuring software platform 122. When accessing development platform 140, an interface 113 may be used to view integration offers 114 of computing products, services, and code integrations for the computing products and services on software platform 122. In some embodiments, the computing services of service provider server 130 that may be viewed and implemented with software platform 122 based on integration offers 114 may include processes for merchant sales, transaction processing, inventory, return or exchange, risk analysis, and other services a merchant may require during the course of their business and sales through software platform 122, such as to provide, market, and/or sell products, services, and other items to customers and/or assist customers with purchases.

During use of developer application 112, interface 113 may be presented to a developer or other user of the merchant, which may be used to access and view a corresponding website or application of development platform 140 associated with service provider server 130. Interface 113 may enable the developer to engage in development of software platform 122 and integration of computing services of service provider server 130 with software platform 122 via development platform 140 of service provider server 130. Interface 113 may be used to search for and/or request computing services, as well as provide merchant information including information associated with the software configurations and code of developer application 112, searches and requests by the merchant for computing services, merchant historical information and/or transactional information, and the like. In some embodiments, the merchant may specify, upload, and/or provide information for the computing code of software platform 122, integrations 123 of computing services and API calls with software platform 122, and/or APIs 124 for APIs and API calls used by software platform 122. Interface 113 may be used to view integration offers 114 provided by service provider server 130 and/or accessed through development platform 140 based on one or more intelligently determined and predicted recommendations from the merchant information and other computing service information for the computing services of service provider server 130. Integration offers 114, displayed on interface 113, may include a computing service or other product available through service provider server 130, as well as computing code, documentation, samples, transformer tools, test windows or environments, and the like that is usable to implement the computing service for usage via developer application 112. Such dynamically configured code and presentations of data on interface 113 may include configured code snippets, code packages, SDKs and SDK operations, APIs and endpoints, and the like.

Developer application 112 may be accessible by users via a general browser application and/or general, native, and/or local mobile application configured to retrieve, present, and communicate information over the Internet (e.g., utilize resources on the World Wide Web) or a private network. For example, developer application 112 may correspond to a website accessible via a web browser, which may send and receive information over network 160, including retrieving website information (e.g., a website for an email provider or other messaging service), presenting the website information to the user, and/or communicating information to the website. Developer application 112 may correspond to application data accessible via a dedicated software application provided by the merchant or other entity. Developer application 112 may be associated with merchant accounts and account information for products of service provider server 130 used by the merchant and/or on software platform 122, account information, user financial information, and/or transaction histories, which may be associated with electronic transaction processing services provided by service provider server 130 for merchants.

Developer device 110 may further include or have access to a database 116, which may correspond to different types of data storage and components including cloud computing storage nodes, remote data stores and database systems, distributed database systems over network 160, and the like used to store various applications and data. Database 116 may include, for example, identifiers such as operating system registry entries, cookies associated with developer application 112 and/or other applications, identifiers associated with hardware of developer device 110, and/or other appropriate identifiers, such as identifiers used for payment/user/device authentication or identification, which may be communicated as identifying the user/developer device 110 to service provider server 130.

Developer device 110 includes at least one network interface component 118 adapted to communicate with merchant server 120, service provider server 130, and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Merchant server 120 may be maintained, for example, by a merchant that may utilize software platform 122 to provide products to users, such as items and services for sale, which may be browsed and purchased through an online digital platform and via computing devices including client device 150. In this regard, merchant server 120 may provide software platform 122 through a native software application and/or website and browser applications. Software platform 122 may offer products to users, such as items and services for sale, which may utilize the computing services of service provider server 130 through computing code integrations. Merchant server 120 may therefore provide software platform 122 to client device 150 for engagement with the merchant's products and use of integrated computing services, as discussed herein. In one example, merchant server 120 may be provided by a merchant or multiple merchants including a merchant marketplace provider that allows multiple merchants to offer products for sale. However, in other embodiments, merchant server 120 may correspond to another type of entity that may have and/or utilize a software platform accessible via a native software application and/or a browser application of the client devices for users to access and view data, as well as engage with integrated computing services of service provider server 130.

Merchant server 120 of FIG. 1 includes and/or is associated with software platform 122 and a network interface component 128, implementations of which are discussed further below. Software platform 122 may correspond to executable processes, procedures, and/or applications with associated hardware. In other embodiments, merchant server 120 may include additional or different modules having specialized hardware and/or software as required.

Software platform 122 may correspond to one or more processes to execute modules and associated specialized hardware of merchant server 120 to provide an online digital platform where users may access data for a merchant or other entity via an application, such as a resident software application and/or a browser application. In this regard, software platform 122 may correspond to specialized hardware and/or software that may deploy and provide software platform 122 over network 160 for access by client devices 150. In some embodiments, software platform 122 may be used to offer and/or provide products for sale, such as items and/or services. However, other types of platforms, data, and the like may also be provided over network 160 to client device 150 and other devices and servers. Software platform 122 may be configured to include and/or utilize computing services of and/or provided by service provider server 130, such as through integrations 123 that may include and/or utilize APIs 124 to call service applications 132.

In this regard, software platform 122 may provide features, services, and other operations to customers of a merchant, which may include merchant sales operations, POS device processing and/or operations, online merchant marketplaces, sales and inventory services, and the like. Software platform 122 may include integrations 123 that correspond to computing code, API calls and/or call structures, code dependencies, and the like. Computing services of merchant server 120 may be implemented on and/or with software platform 122 using integrations 123, such as code integrations of those computing services associated with an account, payment and/or electronic transaction processing services, and the like. As such, software platform 122 may utilize such computing services of service provider server 130 with the merchant's customers through integrations 123.

In some embodiments, the computing services implemented and integrated with software platform 122 may further include processes for merchant sales, inventory, return or exchange, risk analysis, and other services a merchant may require during the course of their business and sales, such as to provide, market, and/or sell products, services, and other items to customers and/or assist customers with purchases. In this regard, software platform 122 may correspond to specialized and/or specifically configured computing code developed by a merchant, developer, or other user via developer device 110, such as based on integration offers 114, to provide applications, websites, resources, and data based on the account and/or computing services. Software platform 122 may provide and/or process items for sale with client device 150 and/or a user interacting with software platform 122 via client device 150 and/or another computing device (e.g., a POS device, etc.). In certain examples, software platform 122 may be accessible over the Internet and provide for sales with client device 150 over network 160. Software platform 122 may utilize integrations 123 with APIs 124 to interact with service provider server 130.

In some embodiments, software platform 122 may correspond to and/or be used to configure a checkout application at a physical merchant location, such as the application(s) of a point-of-sale (POS) device used to provide sales at physical locations. For example, software platform 122 may be used to establish a transaction once a user/employee associated with client device 150 has selected one or more items for purchase and/or entered the item(s) to the transaction for processing. Once a payment amount is determined for the item(s) to be purchased by the user, software platform 122 may request payment for the transaction. Payment may be provided using electronic transaction processing services enabled and/or provided to merchant server 120 after incorporating and/or integrating computing services of service provider server 130. Such computing services may be recommended to the merchant for integration with computing code based on integration offers 114, as discussed herein. In this regard, payment may be received from a user and may be processed using merchant server 120 using integrations 123 and/or APIs 124, such as using integrations 123 to call service provider server 130 using APIs 124. After receipt of payment and/or confirmation of the payment, software platform 122 may then process a payment to the merchant associated with merchant server 120.

In some embodiments, software platform 122 may be used to host, provide, and/or access and maintain a website of the merchant, a web-based application, or the like, which may also be configured based on computing services provided by service provider server 130 and implemented with APIs 124 and the like using integrations 123. The website may be operated, hosted, updated, and provided to end user devices and other systems or servers. The website may correspond to a hosted website having webpages that may include parent and child webpages where customers and service providers may browse items and other services provided by a corresponding merchant, engage in electronic transaction processing, provide customer support and feedback, and the like. The website may be provided through one or more webpages having of Hypertext Markup Language (HTML) code, Extensible Markup Language (XML) code, JavaScript code, and/or Cascading Style Sheets (CSS). In other embodiments, software platform 122 may provide data for an application that may be installed on client devices of users and used to access the merchant's data, marketplace, items, and the like, as well as use the computing services of service provider server 130 through such application. As such, merchant server 120, and software platform 122 in particular, may interact with development platform 140 to provide information for software platform 122 so that intelligent recommendations of integrations 123 may be recommended and/or updated.

Service provider server 130 may be maintained, for example, by an online service provider, which may provide computing services and operations via one or more digital platforms, applications, websites, and the like. Service provider server 130 may provide computing services to various entities, which may require product sign-up and code integrations using an AI engine 146, as discussed herein. In one example, service provider server 130 may be provided by PAYPAL®, Inc. of San Jose, CA, USA. However, in other embodiments, service provider server 130 may be maintained by or include another type of service provider.

Service provider server 130 of FIG. 1 includes and/or is associated with development platform 140, service applications 132, a database 136, and a network interface component 138, implementations of which are discussed further below. Development platform 140 and service applications 132 may correspond to executable processes, procedures, and/or applications with associated hardware. In other embodiments, service provider server 130 may include additional or different modules having specialized hardware and/or software as required.

Development platform 140 may correspond to one or more processes to execute modules and associated specialized hardware of service provider server 130 to provide an AI engine 146 and corresponding online digital platform for merchants, developers, and other entities to receive intelligent and personalized recommendations and integrations of computing services on their software platforms. In this regard, development platform 140 may correspond to specialized hardware and/or software used by a merchant or other user associated with developer device 110 to provide operations for identification and recommendation of the computing services of service provider server 130 for use with software platform 122 on merchant server 120. For example, development platform 140 may receive searches for and/or inquiries associated with computing services through UIs 141, such as those requests, searches, browsing actions or histories, and the like for integrating different software platforms with the computing services provided by service applications 132. These requests for computing service usage and integration may be a result of or provided during a merchant onboarding request, computing service search and/or usage request, and/or code migration request for legacy computing services and code. Based on this request, development platform 140 may utilize AI engine 146 to identify recommended computing services and generate computing code for code integration and/or migration.

Further when identifying recommended computing services, development platform 140 may be used to obtain and/or determine merchant data 142 for processing by AI engine 146 to determine computing service and code integration recommendations, new code samples or blocks of code, and the like. For example, AI engine 146 may process merchant data 142 and determine computing services and other products to offer merchants (or other entities), as well as integrations of those computing services with merchant software platforms. In this regard, UIs 141 may be utilized by merchants and other entities to enter merchant data 142 including merchant business and/or customer information, merchant sales or items offered for sale, searches for computing services, preferences or desires for computing service usages (e.g., desired payment solutions and payment processing platforms, networks, financial instruments, etc.), and the like, which may be used to determine computing service recommendations. UIs 141 may include one or more search fields, menus, forms, and/or the like, which may be collected and/or retrieved for merchant data 142, as well as processes for uploading merchant data 142 and/or entering merchant data 142. Further, UIs 141 may be used to browse and/or review different available computing services, as well as access and review past or legacy computing service integrations, code, API calls and call structures, and the like.

Merchant data 142 may include legacy integrations 143, which may correspond to past and/or existing computing code integrations of computing services offered through service applications 132 that may be implemented on corresponding software platforms of merchants, such as on or with developer application 112. Legacy integrations 143 may include legacy computing code, API calls and calls structures, request and response parameters, SDK usage, versioning of code and/or service usage, and the like. With merchant data 142, software platforms 144 may be designated, and information for such platforms may be stored in association with the merchant. As such, software platforms 144 may include designations of code format and/or language, merchant APIs, and the like. Merchant data 142 allows for AI engine 146 of development platform 140 to perform predictive generation of recommendations and code for computing service integrations.

AI engine 146 of development platform 140 may further process computing service data 145 for the computing services offered and/or provided through service applications 132 when determining recommendations of computing services and code integrations. Computing service data 145 may include information for legacy code, APIs, and the like, as well as new, updated, and/or upgraded code, APIs, and the like. AI engine 146 may then generate integration offers 147, which may correspond to recommendations, offers, and/or promotions of certain products of service provider server 130 offered to merchants through their computing services and service applications 132. Integration offers 147 may be predictively determined by AI engine 146 based on training and knowledge of past and/or similar merchants, such as by training and enabling AI engine 146 engine to make inferences based on training data and/or a knowledge base. In some embodiments, integration offers 147 may include discounts, coupons, rebates, and/or other incentives and offers that may incentive a merchant to utilize a product including personalized assistance offers and/or guides. Using computing service data 145, UI customizations 148 may be performed, which may customize and/or personalize one or more of UIs 141 to present integration offers 147 and other recommendations and notifications to merchants via development platform 140. UI customizations 148 may present recommendations to merchants in a more personalized manner that specifically targets computing services and integration code to the needs of the merchant and merchant's software platform.

In some embodiments, recommendations and integration offers 147 may be determined by AI engine 146 using one or more ML models or other AI techniques including deep learning and NNs, rule-based engines, LLMs and generative AIs, and the like. For example, to generate integration offers 147 and/or computing code for code integrations, an LLM of AI engine 146 may process LLM prompts, merchant data 142, and/or computing service data 145 for intelligent generation of recommendations and other offers for computing service and code integrations. Prompts to LLMs may correspond to instructions, such as text instructions and/or API calls to LLMs, that may be used with the data to prompt LLMs and request LLM responses from LLMs. For example, the instructions in one or more LLM prompts may correspond to instructions to LLMs to review merchant data and available computing services to recommend computing services and/or generate code using code samples and the training and knowledge base of the LLMs. LLM prompts may include and/or be associated with prompting strategies that may be used to prompt LLMs through different questions, statements, calls, and the like (e.g., zero, one, and/or few-shot call prompting, question-and-answering prompting, chain-of-thought prompting, etc.). LLM prompts may also be limited by “token” or word/character/data size limitations, and as such, multiple prompts may be used where integration offers 147 have different data for LLM generation

In this regard, AI engine 146 of development platform 140 may implemented trained ML models and LLMs, such as one or more deep learning models, AI or ML models, NNs and/or deep NNs (DNNs), conversational AIs, or the like, for predictive recommendations and code generation. LLMs may be general or specialized (e.g., domain-specific, such as code generation-specific) for language and/or code generation. ML models may be trained based on ML features and/or variables for processing to intelligently generate an output. For example, ML features or variables may correspond to individual pieces, properties, characteristics, and/or other inputs for an ML model and may be used to cause an output by that ML model. In this regard, AI engine 146 of development platform 140 may include DNNs, MLs, LLMs, generative AIs, and/or other AI models trained using training data having data records that have columns or other data representations and stored data values (e.g., in rows for the data tables having feature columns) for the features. When building models, training data may be used to generate one or more classifiers and provide recommendations, predictions, and/or other outputs based on those classifications and an ML or NN model algorithm and architecture. The algorithm and architecture for AI engine 146 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, and/or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values include language generation. Thus, when the models of AI engine 146 are used to perform a predictive analysis and output of language generation, the input data may provide a corresponding output based on the trained classifications.

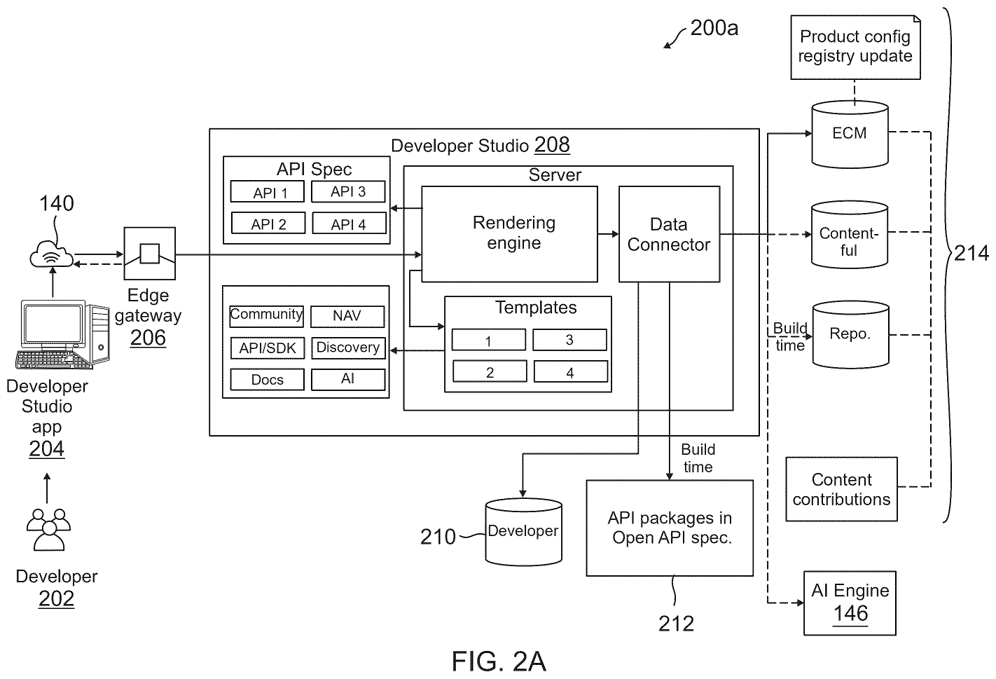

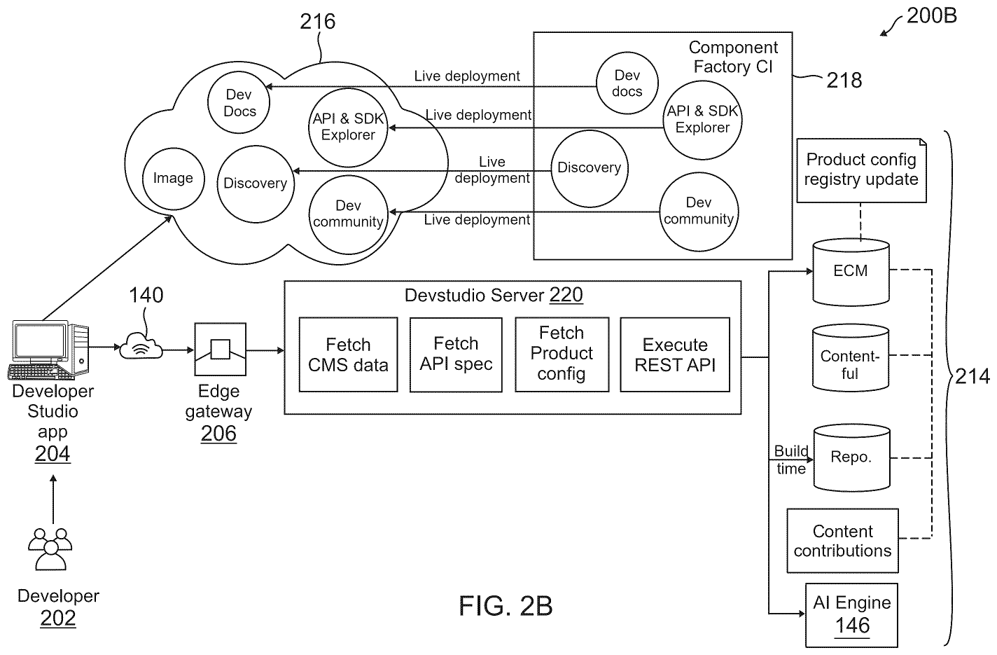

Layers, branches, clusters, or the like may be trained by using training data associated with data records of interest, such as computing code, code specifications or development documents, API and API call structures or API specifications, previous code integrations, and the like. By providing training data, the nodes in the hidden layer may be trained (adjusted) such that an optimal output (e.g., a classification) is produced in the output layer based on the training data. By continuously providing different sets of training data to ML models and/or penalizing DNNs when the outputs are incorrect, the different models of AI engine 146 (and specifically, the representations of the nodes in the hidden layer) may be trained (adjusted) to improve its performance in data classifications and predictions. Adjusting of the models may include adjusting the weights associated with each node in the hidden layer. As such, AI engine 146 may be used for the determination of integration offers 147 and UI customizations 148, which may be provided to developers 202 via a developer (dev) studio 208, as discussed in further detail with regard to FIGS. 2A and 2B below.

Service applications 132 may correspond to one or more processes to execute modules and associated specialized hardware of service provider server 130 to process a transaction and/or provide other computing services to users. For example, service applications 132 may be used to process payments and other services to one or more users, merchants, and/or other entities for transactions, where merchants may integrate use of one or more of service applications 132 through generation of new code and/or code integrations by development platform 140, which may be offered to merchants and other entities through integration offers 147 and UI customizations 148. In this regard, service applications 132 may be used to send and receive payments, including those payments that may be enabled through the website and/or application corresponding to software platform 122 after integrating use of those services through code generation and/or migration by development platform 140. A merchant payment account for use of these services may be accessed and/or used through a browser application and/or dedicated payment application, which may allow for use of the computing services on and/or with software platform 122. Service applications 132 may process payments and may provide transaction histories to software platform 122 and/or another user's device or account for transaction authorization, approval, or denial of the transaction for placement and/or release of the funds, including transfer of the funds between accounts.

Further, service applications 132 may provide different computing services, including social networking, microblogging, media sharing, messaging, business and consumer platforms, etc. These computing services may be used by customers and users, such as through user devices, and may be implemented on different merchant platforms, websites, and/or applications. For example, software platform 122may implement one or more of the computing services of service applications 132 and may call those services using those integrations through integration calls 134. Integration calls 134 may be used to process data with software platform 122 and provided requests and responses for data processing.

Service applications 132 may provide additional features to service provider server 130. For example, service applications 132 may include security applications for implementing server-side security features, programmatic client applications for interfacing with appropriate application programming interfaces (APIs) over network 160, and/or other types of applications. Service applications 132 may contain software programs, executable by a processor, including one or more GUIs and the like, configured to provide an interface to the user when accessing service provider server 130, where the user or other users may interact with the GUI to view and communicate information more easily. Service applications 132 may include additional connection and/or communication applications, which may be utilized to communicate information to over network 160.

Additionally, service provider server 130 includes or may access database 136. Database 136 may store various identifiers associated with developer device 110, as well as account data, including payment instruments, financial information, account balances, and authentication credentials, as well as transaction processing histories and data for processed transactions. Database 136 may include information for merchants that may be used to recommend computing services and code integrations to merchants. Although database 136 is shown as residing on service provider server 130 as a database, in other embodiments, other types of data storage and components may be used including cloud computing storage nodes, remote data stores and database systems, distributed database systems over network 160 and/or of a computing system associated with service provider server 130, and the like.

Service provider server 130 may include at least one network interface component 138 adapted to communicate with developer device 110 and/or other devices and servers over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Client device 150 may be implemented as a computing device of a user, such as a consumer or a customer of a merchant associated with merchant server 120, that may utilize appropriate hardware and software configured for wired and/or wireless communication with merchant server 120 and/or service provider server 130. For example, client device 150 may be utilized by a consumer to access software platform 122 to browse items for sale and engage in electronic transaction processing. Client device 150 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly, such as those of a plurality of consumers engaging in shopping and purchasing from the merchant via software platform 122.

Client device 150 of FIG. 1 contains an application 152 and a network interface component 156. Application 152 may correspond to executable processes, procedures, and/or applications with associated hardware. In other embodiments, client device 150 may include additional or different modules having specialized hardware and/or software as required.

Application 152 may correspond to one or more processes to execute software modules and associated components of client device 150 to provide features, services, and other operations for a user, which may include accessing software platform 122 and/or engaging in electronic transaction processing using computing services provided by service provider server 130 via software platform 122. In this regard, application 152 may correspond to software utilized by a user of client device 150 to access a website or application data (e.g., for a mobile application, rich Internet application, or resident/native software application) that may display one or more user interfaces that allow for interaction with software platform 122, for example, to browse items for sale, select and/or checkout for items, process transactions, login to accounts, and/or receive receipts and transaction histories. Thus, application 152 may display software platform data 153 for software platform 122 that allows the user to interact with software platform data 153 via one or more user interfaces. Software platform data 153 may allow for the user to browse the merchant's platform, products, and the like, as well as use integrated services 154 corresponding to the computing services of service provider server 130 integrated in and implemented on software platform 122. As such, in various embodiments, application 152 may correspond to a general browser application configured to retrieve, present, and communicate information over the Internet (e.g., utilize resources on the World Wide Web) or a private network. However, in other embodiments, application 152 may include a native and dedicated application associated with merchant server 120, service provider server 130, and/or another entity that may access data for, present, and process software platform data 153 for use with integrated services 154 via one or more interfaces.

Application 152 may be associated with account information, user financial information, and/or transaction histories for electronic transaction processing, including processing transactions using financial instrument or payment card data on software platform 122 using integrated services 154, such as after code, APIs and the like have been configured for integrations 123 using development platform 140, as discussed herein. Application 152 may be utilized to enter, view, and/or process items the user wishes to purchase in a transaction, as well as perform peer-to-peer payments and transfers, using integrated services 154. In this regard, application 152 may provide transaction processing through integrated services 154, such as through a user interface enabling the user to enter and/or view the items that the user associated with client device 150 wishes to purchase in a transaction. A payment may be requested to be made on software platform 122 using integrated services 154, and application 152 may be used to specify user financial information, such as credit card data, bank account data, or other funding source data, as a payment instrument when providing payment information to service provider server 130 using integrated services 154. Additionally, application 152 may utilize a digital wallet associated with an account with a payment provider as the payment instrument, for example, through accessing a digital wallet or account of a user through entry of authentication credentials and/or by providing a data token that allows for processing using the account. Application 152 may receive a receipt or other information based on transaction processing of the transaction via integrated services 154. In some embodiments, additional services may be provided via application 152, including social networking, media posting or sharing, microblogging, data browsing and searching, online shopping, and other services available through service provider server 130.

Client device 150 includes at least one network interface component 156 adapted to communicate with merchant server 120, service provider server 130, and/or another device or server. In various embodiments, network interface component 156 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100

FIGS. 2A and 2B are exemplary system architectures 200a and 200b for providing a development platform where merchants and other entities may view recommendations of code integrations for computing services on software platforms, according to an embodiment. System architectures 200a and 200b may include components of service provider server 130 that may be utilized by developer device 110 for computing service recommendations and code integrations, as discussed in reference to system 100 of FIG. 1. In this regard, system architectures 200a and 200b may correspond to a production computing environment where development platform 140 executes one or more operations for assisting merchants in discovering and developing computing services for use with their merchant software platforms.

Referring now to system architecture 200a of FIG. 2A, an embodiment of development platform 140 is shown that may utilize a server-side reading (SSR) of data to provide recommendations of computing services and corresponding integrations for software platforms of merchants. For SSR in system architecture 200a, a component factor for each UI application may be provided server-side and bundled in a single application that is downloaded, accessed, and/or provided to merchants for use client-side during runtime and application development. In system architecture 200a, developers or other users for merchants may utilize computing devices, such as developer device 110, to access a server and receive a developer studio application (app) 204 from the SSR, which may be rendered client-side to provide access to and use of development platform 140 of service provider server 130 from the server. As such, developer studio app 204 may correspond to a SSR of data presented in developer application 112 on developer device 110.

In this regard, SSR of data for developer studio app 204 may provide merchants with an initial page and/or data load for developer studio app 204 where merchants may view integration offers 147 and UI customizations 148 based on intelligently determined and predicted recommendations of computing services and code integrations by AI engine 146. SSR may be performed for page load speeds and performance initially, where developer device 110 may view the experience server-side from the server reading the data and outputting/rendering of developer device 110. SSR allows for the experience to initially be loaded and executed server-side, where after loading of the experience for the UI application on a browser or in an application of developer device 110, a client-side rendering (CSR) may be performed, as shown in FIG. 2B.

Developers 202, such as merchants, may utilize developer studio app 204 to gain access to development platform 140 where developers 202 may access various features, information, and recommendations of computing services and other products of a service provider. Developer studio app 204 may correspond to a client-side software application from different UI frontend applications provided by the service provider and may access server-side data and processes through network 160 via an edge gateway 206 of the service provider. Edge gateway 206 may correspond to a gateway service that connects developer studio app 204 on computing devices for developers 202 to dev studio 208 server-side for the service provider. Dev studio 208 may therefore correspond to the set of components, applications, and data of development platform 140 that are loaded and made available from the SSR. Dev studio 208 may be accessible when generating the SSR of developer studio app 204 for bundling of data for the application and presentation in developer application 112 on developer device 110. Edge gateway 206 may further correspond to a cache enabled at an edge server to improve the latency and avoid roundtrips to the server to render the static contents

Dev studio 208 may provide data for developer studio app 204 at build time (e.g., creation of an instance of the application, downloading, etc.) or runtime. This may include data from a developer database 210, an artifactory 212, and/or product configurations and data 214. For example, developer database 210 may include merchant information, as well as other information relevant to merchant-specific recommendations, software platforms, code integrations, and the like. Artifactory 212 may provide API specifications and schema for different APIs and API calls, while product configurations and data 214 may provide data for the computing services, such as configurations, code, content, and the like. Contents may be retrieved for developer studio app 204 at build time or at runtime based on the resource time. For example, a headless browser (e.g., a web browser without a GUI that includes a uniform resource locator (URL) bar, bookmarks, etc.) content management store may be provided a runtime, while other content sources including a code repository and/or a universal repository manager may be retrieved and provided in the application at build time. Other contents may include subsidiary API specifications and/or API schema.

Templates for different applications and their computing services, such as code and/or API call templates for code integrations, may be loaded during build time and made available via one or more folders based on the contents. Templates may correspond to samples and/or pre-generated code for integration patterns that can be implemented by merchants on their software platforms, such as a merchant or code developer using developer device 110 to implement a computing service of service provider server 130 with software platform 122. For example, templates may include API call templates or exemplary structures and samples of API calls to an API endpoint. The API calls may therefore enable software platform 122 to call service applications 132 for computing service usage and integration on that platform and via a website and/or native application. As such, templates may allow a merchant to view template or sample API calls and insert corresponding endpoints, identifiers, and the like for integration code generation and/or implementation.

Templates may also include and/or correspond to a webpage or interface data that may display the sample or pre-generated code. In this regard, templates may be identified by a URL or other identifier, which allows mapping of the URL to components for data display in a UI presentation during runtime. This allows for a rendering engine to load the theme, control layouts, and final content to display to merchants through the templates. AI engine 146 may utilize the templates, such as a webpage having one or more sample API calls to the corresponding computing service or other software product, to create a tailored UI with recommendations of API code integrations to a merchant. These templates may therefore correspond to reusable webpage or UI data for code integrations. The data provided from the templates may include recommendations determined using AI engine 146 for the merchants, which may guide customized configurations of UI presentations and outputs. As such, merchants may view merchant-specific portals and UIs for computing service integrations through developer studio app 204.

Referring now to system architecture 200b of FIG. 2B, an embodiment of development platform 140 is shown that may utilize a CSR of developer studio app 204 to provide recommendations of computing services and corresponding integrations for software platforms of merchants. In contrast to system architecture 200a, in system architecture 200b, developer studio app 204 may interact with a content delivery network (CDN) 216 where static assets and application components may be deployed directly for content to developer studio app 204. For example, with a CSR, once the user experience, UIs, data, and the like for developer studio app 204 have been loaded on a browser or in an application of developer device 110 (e.g., application 112), CSR may be provided to avoid having to entirely reload data server-side during navigations, data input and/or processing (e.g., code transformations or recommendations from AI engine 146), and the like. As such, the CSR may be used to only reload specific data and content from CDN 216 for the particular page, product, and/or integration that the merchant has navigated to and is view. As such, system architecture 200b represents a later state of application 112 on developer device 110 after initially accessing and using development platform 140 via a SSR from service provider server 130.

For example, a component factory 218 may provide application data for various applications and computing services available for integration including developer documents, API and SDK explorers and data, application discovery, and/or a developer community (e.g., chat, forum, social media, etc.). Edge gateway 206 may, instead of caching at the edge server due to CSR, interact with a dev studio server 220, which may provide fetch operations to obtain further data for product configurations and data 214. This may be done at runtime through the fetch operations to provide CSR of data from product configurations and data 214.

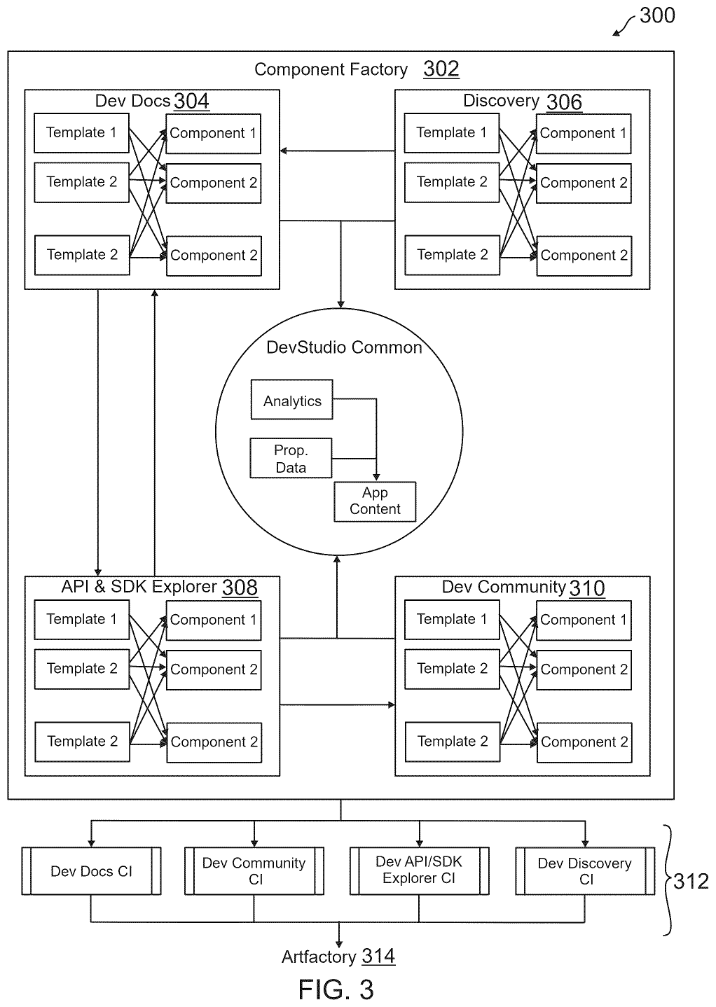

FIG. 3 is an exemplary diagram 300 of components of a development platform for code integrations, according to various embodiments. Diagram 300 represents the components of different computing services and code integrations that may be utilized by service provider server 130 in system 100 of FIG. 1 to provide recommendations of computing services and code integrations to developer device 110. In this regard, the components of a component factory 302 in diagram 300 may be used to generate integration offers 147 and UI customizations 148 to recommend computing services to merchants, as well as provide information on code integrations to call and utilize such services.

Component factory 302 includes developer documents 304, service discovery templates 306, an API and SDK explorer 308, and a developer community 310. This data may be used by a developer studio process of component factory 302 to generate the components and other data necessary to recommend computing services and provide information for integration of such services to software platforms. In this regard, a development team may work with component factory 302 to develop components for a user experience design. Component factory 302 may provide a react storybook for different features to mock all test data for the component to be developed. The templates and/or pages may be created by leveraging the previously created components and/or creating new components using the data of component factory 302. For example, the cross-pollination between component factories allows the reuse of the component, as well as collaboration on components.

Component factory 302 may include data and processes for creation and/or maintenance of a data repository, UI and computing service components, pages, component publishing (e.g., providing or outputting via UIs), and/or release. During a process to build and deploy a component for a development portal and/or platform, such as information that may be used when recommending computing services via one or more customized UI components, elements, pages, or the like, component factory 302 may be accessed and developer documents 304, service discovery templates 306, API and SDK explorer 308, and/or developer community 310 may be utilized. The components may be developed to provide, offer, and/or maintain products, such as computing services, for use by merchants. As such, the components may be accessed and utilized by a UI engine to generate intelligent recommendations of those computing services for a service provider based on merchant information and computing service availability or usage. The release process may then provide components 312 to an artifactory 314, which may store the data for access by the AI engine when generating and outputting predictions, decisions, and/or recommendations associated with the computing services and merchant use, interest, and/or development. This may include recommendations, as well as code generation for software integration with software platforms (e.g., to execute calls between applications and other platforms).

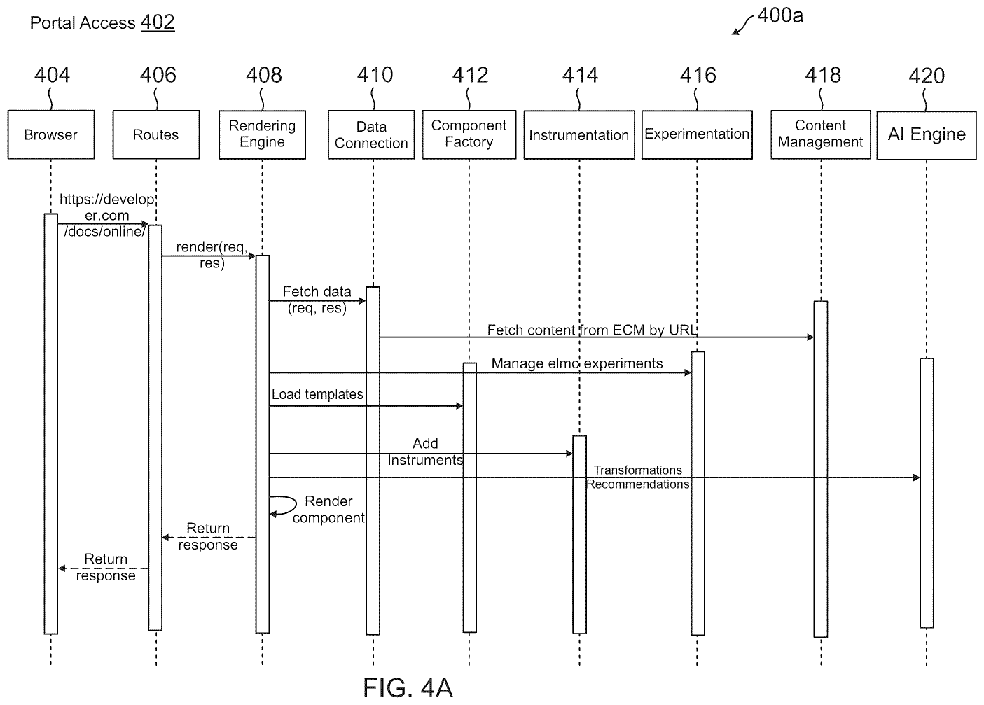

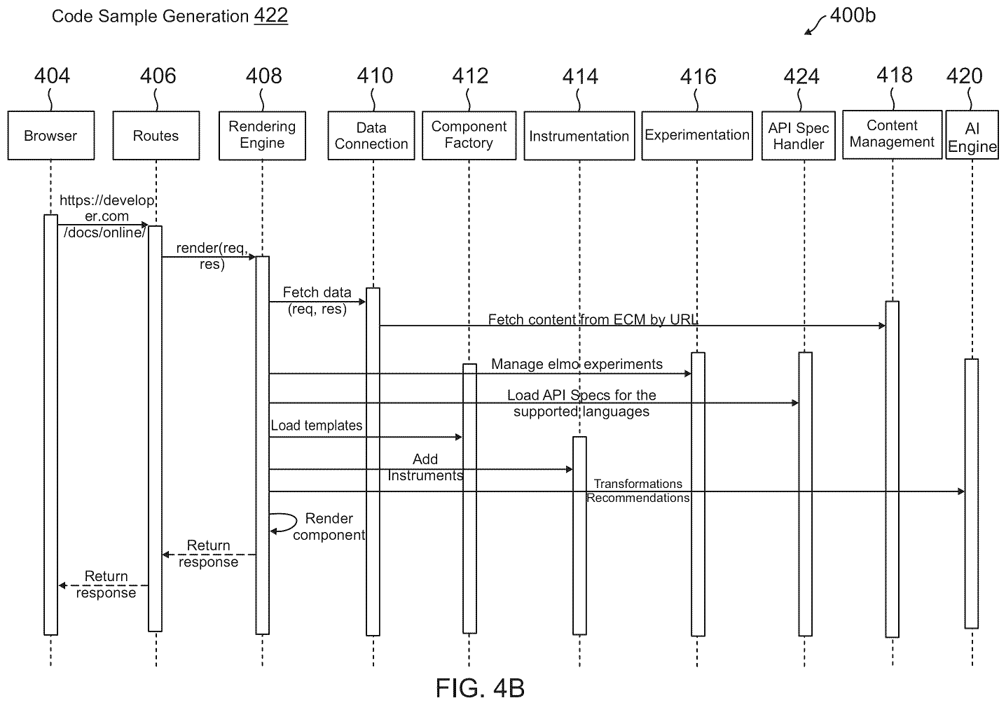

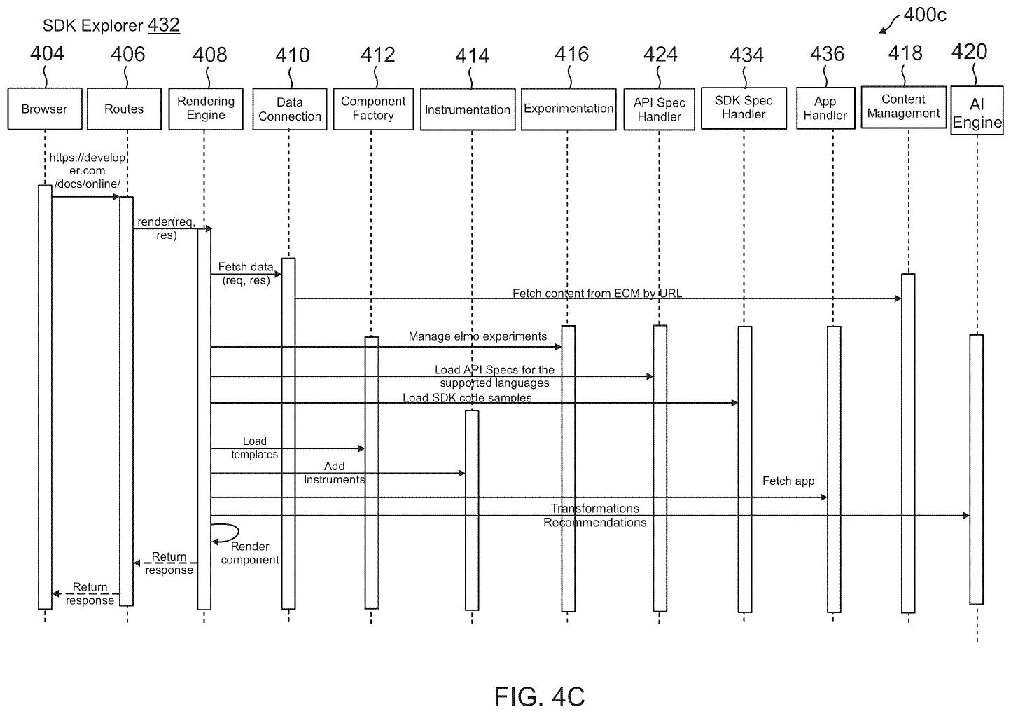

FIGS. 4A-4C are flowcharts 400a-400c of exemplary calls executed by a development platform for code integrations. Flowcharts 400a-400c display a set of calls and operations between devices, systems, and components shown in system 100 of FIG. 1, based on use of development platform 140 of service provider server 130 for recommendations of computing services and code integrations. As such, flowcharts 400a-400c represent requests and other calls from a browser 404 on a client device of a merchant that may be processed to provide recommendations of computing services with corresponding code samples or instructions for integrations of the services with software platforms.

In flowchart 400a, a request for a portal access 402 is shown being handled using the calls between the endpoints shown. For example, browser 404 may access a website for a developer studio application and/or platform, such as through a URL. A routes endpoint 406 may receive the request and provide a route for rendering documents to support the developer requirements. A rendering engine 408 may execute a fetch call to fetch data using a data connector 410 from a content management 418. API calls may be exchanged between the APIs for the endpoints and/or platforms, which may provide the content back to rendering engine for rendering in browser 404 (e.g., on a displayed webpage interface).

Prior to returning responses, rendering engine 408 may also utilize an experimentation handler to fetch content from an experimentation endpoint 416. Experimentation endpoint 416 may be used to experiment with, serve, and/or control content release and provision content to different regions, merchants, accounts, experiences (e.g., web, mobile, native application, etc.), etc. These may correspond to groups of users that may utilize development platform 140. For example, experimentation endpoint 416 may be used to A/B testing of products and product releases, to control product release to certain countries, to ramp up product release and/or release products in certain regions, and/or performing other controlled release of content and products, such as computing services and code integrations of such services. As such, experimentation endpoint 416 may be used to control how templates, pages for code integrations and computing service recommendations, and/or other computing service and code integration content is released and provided to merchants via development platform 140.

A component factory 412 may be used to load templates for various components that may be used to provide information, code and/or code samples, and the like for computing service recommendations, such as the components that may be utilized by an AI engine to intelligently recommend computing services to merchants based on the merchant's information. An instrumentation endpoint 414 may be utilized to add and/or load necessary instrumentation to monitor merchant behavior during use of the developer studio application and/or platform. Rendering engine 408 may then interface with an AI engine 420 in order to request, determine, and/or receive code transformations and/or recommendations of code integrations, which may be used for personalized recommendations and computing code. Rendering engine 408 may then render components and other data for recommendations and personalized UIs, and a response may be returned to routes endpoint 406, which is turn, responds to browser 404 for rendering of the components within the browser application and/or displayed website to provide the merchant with a personalized page and/or interface for portal access 402.

Referring now to FIG. 4B, in flowchart 400b, a request for a code sample generation 422 is shown as being handled by calls exchanged between the endpoints shown. In a similar manner to flowchart 400a, the initial request from browser 404 causes routes endpoint 406 to call rendering engine 408 to retrieve data for rendering using and/or from data connector 410, component factory 412, instrumentation endpoint 414, experimentation endpoint 416, and/or content management 418. However, in order to provide code sample generation 422, an API specification (spec) handler 424 is utilized, which may load the preprocessed code specification (e.g., API request, API response, request/response parameters, API documentation, etc.) based on the content from content management 418. Further, AI engine 420 may be utilized to provide code transformations and/or recommendations based on this loaded code specification. The loaded data from API spec handler 424, as well as any AI generated transformations and/or recommendations by AI engine 420, may then be saved in-application context for the application for rendering engine 408 as a template for component factory 412 to render via rendering engine 408.

Referring now to FIG. 4C, in diagram 400c, a request for an SDK explorer 432 is shown as being handled by calls exchanged between the endpoints shown. In a similar manner to flowcharts 400a and 400b, the initial request from browser 404 causes routes endpoint 406 to call rendering engine 408 to retrieve data for rendering using and/or from data connector 410, component factory 412, instrumentation endpoint 414, experimentation endpoint 416, content management 418, and/or API spec handler 424. As a prerequisite prior to handling, an SDK governance code repository base may be bundled as part of the application manifest, which allows for preparing of an API specification. The language for rendering of the SDK explorer in an SDK preview section of the developer studio application and/or platform may be determined and used, and a dummy API may be created to support SDK execution, which includes sufficient intelligence to construct server-side payloads based on server code changes. Thereafter, when a request is received and processed at rendering engine 408 for SDK explorer 432, an SDK specification handler 434 may be utilized to load code samples for the different combinations of code available to be configured and testing using the corresponding SDK. The loaded data may be saved in-application context for a template from component factory 412.

When responding to the request, an application handler 436 may be called by rendering engine 408 to fetch different applications and computing services that may be configured for the SDK. AI engine 420 may be used to transform any code utilized by or provided through the SDK to an implementation that may be used by the specific merchant and/or for the specific request, as well as make any recommendations of code integrations based on the SDK and other information for the merchant's software platform. As such, AI engine 420 may intelligently configure code for transformations and make recommendations for the request and based on the SDK. A code editing process may then be provided where the request parameters, query parameters, and/or request body for API calls may be modified, which may re-render a page when modified. The changes may be saved in a user session, which may not require persisting to a database until finalization or longer-term storage requests. The application context may be used to update the state of the application so that content for the computing service, code editor, and SDK preview sessions may be rendered.

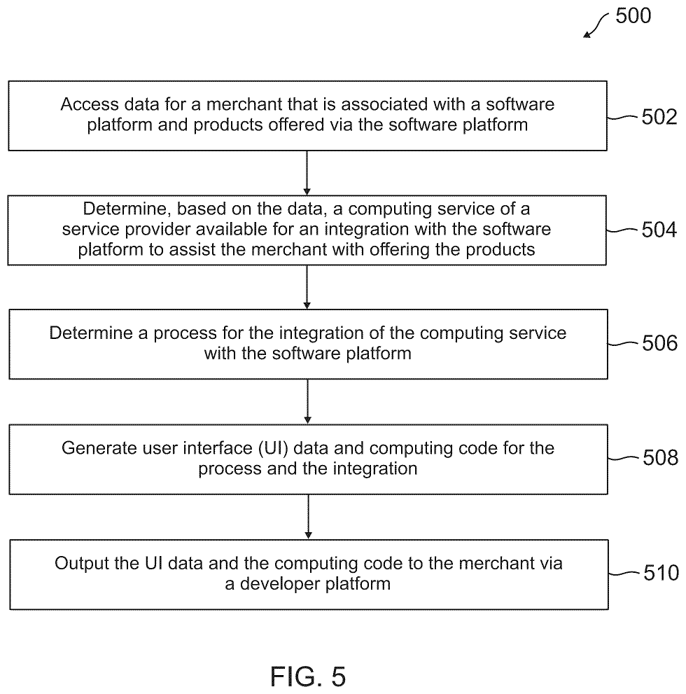

FIG. 5 is a flowchart 500 for an application and website development platform for automated recommendations of code integration options, according to an embodiment. Note that one or more steps, processes, and methods described herein of flowchart 500 may be omitted, performed in a different sequence, or combined as desired or appropriate.

At step 502 of flowchart 500, data for a merchant is accessed, where the data is associated with a software platform and products offered via the software platform. For example, in system 100 of FIG. 1, a merchant associated with developer device 110 may want to integrate and/or migrate a previous integration of computing code for use of a computing service provided by service provider server 130 on developer application 112. As such, computing services of service provider server 130 may be provided on other separate and/or third-party platforms through code integrations provided intelligently using development platform 140. To determine computing services of interest and/or use by the merchant and/or for the merchant's customers via developer application 112, merchant information may be provided and/or determined, such as merchant business information, customer information, information for products or services (e.g., real or virtual items that can be sold by merchants) offered by the merchant, and/or merchant interests and preferences for computing services and solutions (e.g., preferred payment mechanisms, preferred payment processors, etc.).

Additionally, the service provider may determine information regarding the merchant's searches, queries, and/or browsing history for computing services and products of the service provider. Other information regarding software platform data, code, and/or code requirements (e.g., capabilities, specifications, SDDs, etc.) may be provided. Service provider server 130 may receive such data, including APIs and API documentation, API calls and structures, code snippets, packages, files, written code, and/or other executable computing code, as well as may execute API calls to the merchant's platform to determine. In this regard, the data provided with the request for the merchant platform code integration may include information associated with the merchant's software platform that allows for code to be written, developed, and/or generated for the platform when integrating the service provider's computing services with the merchant's software platform. In some embodiments, this may include existing code and/or legacy code and code integrations, such as legacy API integrations and specifications used to call legacy APIs of the service provider (e.g., older and/or out-of-date APIs).

At step 504, based on the data, a computing service of a service provider available for an integration with the software platform to assist the merchant with offering the products is determined. Development platform 140 may utilize merchant data 142 and computing service data 135 to intelligently determine, for example, using an AI engine and/or one or more AI models, an offer or recommendation of a computing service of interest or potential use to the merchant for integration with developer application 112. For example, the computing service may be provided through service applications 132 and may be called through integration calls 134 to provide such computing services via developer application 112 to users, such as customers. In some embodiments, this may be associated with account services and/or login, electronic transaction processing, authentication, risk management and/or analysis, fraud detection, and the like. As such, the AI engine may predictively determine, based on the merchant's searches and/or queries, interests, products sold, customers, previous service usage, and the like, what other computing services and products of service provider server 130 that may be of interest or use to the merchant.

At step 506, a process for the integration of the computing service with the software platform is determined. In order to integrate a computing service associated with service applications 132 with developer application 112 so that integration calls 134 may be made by developer application 112 to service applications 132, computing code, API call structures and/or data, and the like may be required to be integrated with and deployed for execution by developer application 112, such as by configuring and/or updating the computing code of developer application 112. As such, an SDK, code snippets or packages, API call samples, API call parameters and code limitations or configurations, may be determined, which may indicate a process by which an integration of the computing service may be performed with the software platform of the merchant. Further, past integrations with the software platform or other software platforms, including those of other merchants, as well as API documentation, code configurations and/or documents, development documents, and the like may be used for determination of the process to integrate the computing service with the software platform. As such, the process may provide computing code, instructions, API call configurations, and the like for the integration.

At step 508, UI data and computing code for the process and the integration is generated. Development platform 140 may generate computing code using an LLM or other AI process by which computing code may be automatically generated. In this regard, source code for the code integration requested by the merchant, such as new code integration and/or code integration migration to new code implementations and/or services, may be generated by the LLM. The LLM may be prompted, and a code package may be generated by the LLM based on information for the merchant, the software platform, and the like. With the computing code, a UI of development platform 140 may be customized and/or specifically configured for the merchant to display the merchant-specific recommendation and integration of the computing service for developer application 112. For example, UIs 131 may be specifically configured based on integration offers 147 to generate UI customizations, which may display a personalized UI, page, or the like within a web browser or software application. The UI may be personalized in this manner to provide an AI-based assistance with finding and integrating computing services with the merchant's software platform(s).

At step 510, the UI data and the computing code is output to the merchant via a developer platform. Development platform 140 may output UI customizations 148 through UIs 131 when accessed and viewed by the merchant using developer device 110 or another device, application, website, etc. This allows the merchant to view a personalized portal and platform by which the merchant may receive customized recommendations and instructions for integrating computing services with software platforms. Thus, using the above-described systems and methods, a personalized development platform and portal may be provided to merchants where intelligently recommended computing services and code integrations may be more conveniently and efficiently presented and reviews. Merchants may identify computing services that may be useful, as well as engage in code development, in a more streamlined, efficient, and optimized manner. This allows for coordinated communications with merchants and merchant software platforms to facilitate the incorporation of computing code for different computing services on such platforms.

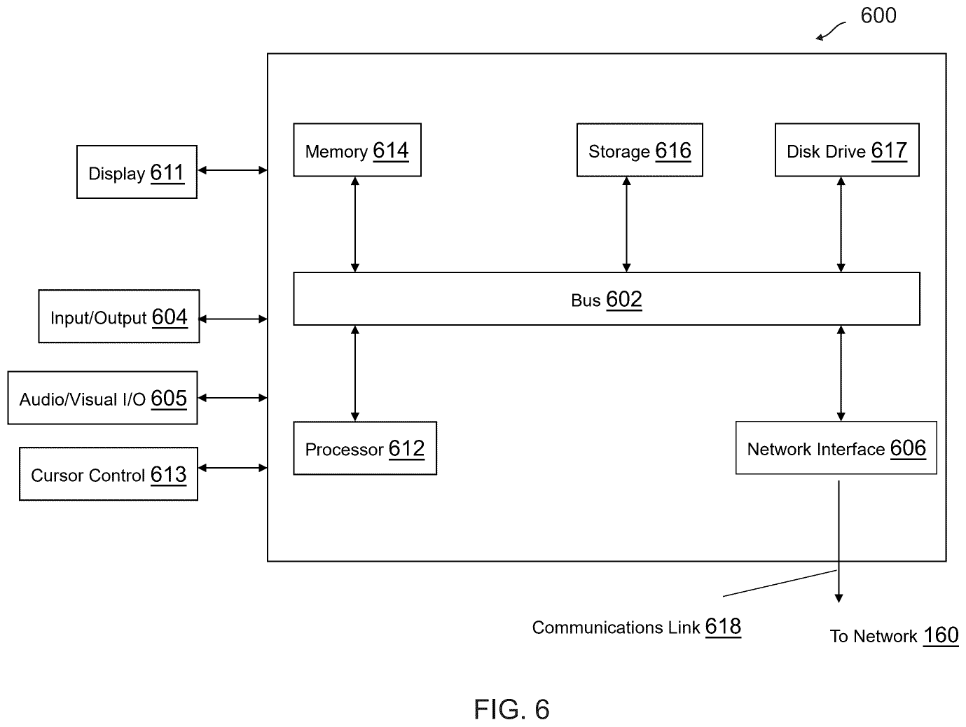

FIG. 6 is a block diagram of a computer system 600 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with network 160. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, images, and/or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output component 605 may also be included to allow a user to use voice for inputting information by converting audio signals and/or use video to capture still or video images and provide video input. Audio I/O component 605 may allow the user to hear audio and/or view video. A transceiver or network interface 606 transmits and receives signals between computer system 600 and other devices, such as another communication device, service device, or a service provider server via network 160. In one embodiment, the transmission is wireless, although other transmission mediums and methods may also be suitable. One or more processors 612, which can be a micro-controller, digital signal processor (DSP), and/or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, and/or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, and/or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
access merchant data for a merchant of a service provider, wherein the merchant data is associated with one or more products offered to customers of the merchant, and wherein the merchant data is further associated with a software platform utilizable by the merchant to offer the one or more products to the customers;
determine, based on the merchant data and using an artificial intelligence (AI) engine configured to predict usages of computing services of the service provider by different software platforms of merchant customers of the service provider, a computing service of the service provider that is capable of being utilized with the software platform when offering, by the merchant, the one or more products to the customers;
determine an integration of the computing service with the software platform of the merchant, wherein the integration enables a use of the computing service by the service provider on the software platform, and wherein the integration comprises integration code that, when executed, integrates the computing service with the software platform utilizable by the merchant;
generate user interface (UI) data for the integration using at least the AI engine, wherein the UI data enables the merchant to access the integration code for the integration of the computing service; and
output the UI data to the merchant when the merchant accesses a UI associated with providing the integration to the merchant.

2. The system of claim 1, wherein executing the instructions further causes the system to:
determine a customized layout of the UI of a development platform based at least on the merchant data, wherein the development platform is utilizable by the merchant to access the integration,
wherein the UI data is presented to the merchant in the UI via the customized layout.

3. The system of claim 2, wherein the customized layout is further determined based at least on the generated UI data and one or more additional merchant recommendations for the computing service, and wherein the customized layout comprises a log of at least one of the integration code or additional computing code for the computing service.

4. The system of claim 1, wherein the computing service is further determined based on at least one of an interest in one or more of the computing services identified for the merchant, a request for one or more of the computing services by the merchant, a search of the computing service, or sales of the one or more products by the merchant.

5. The system of claim 1, wherein executing the instructions further causes the system to:
determine software configuration data for the software platform of the merchant,
wherein the integration is determined based on the software configuration data.

6. The system of claim 1, wherein executing the instructions further causes the system to:
receive a request associated with one or more of the computing services and the software platform, wherein the request comprises a payload associated with computing code of the software platform,
wherein the merchant data is accessed responsive to the request.

7. The system of claim 1, wherein the AI engine is further configured to predict software integrations for the usages of the computing services based on one or more samples of computing code for at least one of the computing services or the different software platforms.

8. The system of claim 1, wherein the AI engine comprises at least one large language model (LLM) that determines the computing service and generates the integration code.

9. The system of claim 1, wherein the integration code, when executed, integrates the computing service on the software platform of the merchant that enables use by merchant customers via a website or an application corresponding to the software platform, and wherein the computing service comprises at least one of a user authentication service, a transaction processing service, or a digital account service.

10. A method comprising:
receiving entity data for an entity that utilizes a software platform for interactions with end users, wherein the entity data is associated with a potential usage of computing services offered by a service provider to the entity, and wherein the entity data is based on at least one of past service usages by the entity or a search history by the entity;
predicting, based on the entity data and using an artificial intelligence (AI) engine configured to predict usages of computing services of the service provider by different software platforms of entities, one of the computing services for an integration with the software platform for the potential usage;
determining a recommendation for the integration of the one of the computing services with the software platform, wherein the recommendation comprises one or more instructions for implementing the one of the computing services in computing code of the software platform;
generating user interface (UI) data for a UI of a development platform that presents the recommendation to the entity; and
causing the UI data to be displayed to the entity through the development platform when accessed by the entity.

11. The method of claim 10, wherein the recommendation comprises computing code for the one of the computing services on the software platform of the entity.

12. The method of claim 11, wherein prior to the generating the UI data, the method further comprises:
generating the computing code based on the software platform and one or more code integration samples.

13. The method of claim 11, wherein the computing code is generated using a large language model (LLM) that automatically creates the computing code executable by the software platform.

14. The method of claim 10, wherein the integration comprises a code migration from a previously used application programming interface (API) of the one of the computing services to a new API currently implemented with the one of the computing services.

15. The method of claim 10, wherein the UI data comprises a code review log that displays computing code for the integration of the computing service.

16. The method of claim 15, wherein the code review log further displays at least one of an API call structure, a communication, or a configuration associated with an API of the one of the computing services.

17. The method of claim 10, wherein the one of the computing services is predicted based on a search query by the merchant for a product provided by the service provider.

18. The method of claim 17, wherein the product is associated with electronic transaction processing provided by the service provided on behalf of the entity on the software platform of the entity.

19. A non-transitory machine-readable medium having stored thereon machine-readable instructions executable to cause a machine to perform operations comprising:
predicting a computing service for a software platform of a merchant based on merchant data for the merchant, wherein the predicting is performed using an artificial intelligence (AI) engine configured to predict usages of the computing service of a service provider by different software platforms;
determining an integration of the computing service with the software platform, wherein the integration comprises computing code that, when executed, implements one or more usages of the computing service via the software platform;
generating user interface (UI) data for a UI of a development platform that presents the integration to the merchant; and
causing the UI data to be displayed to the merchant when accessed via the development platform.

20. The non-transitory machine-readable medium of claim 19, wherein the predicting is responsive to a search request of a plurality of computing services based on a desired implementation of at least one of the plurality of computing services on the software platform.
